(19) United States
(12) Patent Application Publication
(10) Pub. No.: US 2002/0159480 A1
(43) Pub. Date: Oct. 31, 2002

(54) Method, apparatus, and system for bandwidth control

(76) Inventors: Osamu Sekihata, Kawasaki (JP); Naomasa Yoshimura, Kawasaki (JP); Shiro Mori, Kawasaki (JP); Hajime Chiwata, Kawasaki (JP); Kiyotaka Shikata, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/002,025

(22) Filed: Nov. 15, 2001

(30) Foreign Application Priority Data
Apr. 26, 2001 (JP) 2001-129137

(51) Int. Cl. H04J 3/16; H04J 1/16

(52) U.S. Cl. 370/468; 370/389

(57) ABSTRACT

In a method, an apparatus, and a system for a bandwidth control, a packet is held in a buffer, the held packet is read at a line bandwidth, and a read timing of a next packet is controlled, based on a packet length of a counted packet in order that a difference between the line bandwidth and a setting bandwidth assumes a packet interval. Also, by a flow control combined therewith, a bandwidth control is realized as a system without discarding any packet or with a low packet discarding rate.

### BACKGROUND OF THE INVENTION

1. Field of the Invention

The present invention relates to a method, an apparatus, and a system for a bandwidth control, and in particular to a method, an apparatus, and a system for a bandwidth control at the time of transmitting a packet.

Recently, needs have grown for construction of a corporate intranet by an Internet access, so that services of common carriers characterized in an interface with an end user by an IP packet have commenced by various kinds of methods.

2. Description of the Related Art

As a prior art bandwidth control method in a communication using a variable length packet, there is known the Japanese Patent Application Laid-open No.11-346246 disclosing a variable length packet exchange and an exchange method therefor.

In this prior art, transmission packets are classified into a plurality of queue groups to which individual bandwidths are assigned according to header information of the packets, queued within the queue groups by transmission priorities, and read from the queue groups according to the transmission priorities while the bandwidths assigned to the queue groups are guaranteed.

Namely, such a read time that enables a plurality of packets to be read is provided to each queue group, whereby data amount transmitted per unit time is controlled by a threshold value assigned within the read time.

Such prior art guarantees a bandwidth control in a long term. However, it has been disadvantageous, as mentioned in this prior art, that a setting bandwidth (e.g. contract bandwidth) which is a restricted bandwidth is exceeded in a short term and that a delay fluctuation time of the packet increases.

### SUMMARY OF THE INVENTION

It is accordingly an object of the present invention to provide a method, an apparatus, and a bandwidth control system which perform a bandwidth control to keep a delay fluctuation time of packet minimum, without exceeding a setting bandwidth even temporarily.

In order to achieve the above-mentioned object, a bandwidth control method according to the present invention comprises the steps of: holding a packet, counting a packet length of the packet, and reading the held packet at a line bandwidth and controlling a read start timing of a next packet, based on the packet length, in order that a difference between the line bandwidth and a setting bandwidth assumes a packet interval.

The bandwidth control method may further comprise the steps of notifying a stop of a packet transmission to a packet transmitting side when a number of packets residing in a buffer exceeds a first threshold value, and performing a flow control to notify a restart of the packet transmission to the packet transmitting side when the number of packets residing in the buffer assumes equal to or less than a second threshold value.

It is preferable to perform the above-mentioned flow control only to a subscriber side. On the other hand, however, the flow control may be performed to an up-link side.

Furthermore, the above-mentioned bandwidth control method may be performed between an MAC layer controller and a physical layer controller.

Also, as shown in FIG. 1, an apparatus realizing the above-mentioned bandwidth control method may comprise: a buffer 31 for holding a variable length packet, a counter 32 for counting a packet length of the packet, and a read controller 33 for reading the packet at a line bandwidth from the buffer 31 and controlling a read start timing of a next packet, based on the packet length, in order that a difference between the line bandwidth and a setting bandwidth assumes a packet interval.

Namely, in the bandwidth control apparatus according to the present invention, the read controller 33 reads the packet at a line bandwidth (line speed) from the buffer 31 to be outputted through the packet length counter 32. Thus, the speed of outputting the packet from the counter 32 is the line bandwidth.

However, since the packet length counter 32 counts the packet length of the packet inputted from the buffer 31 to be notified to the read controller 33, the read controller 33 controls the read start timing of the next packet, based on the packet length so that an interval (i.e. packet interval) from the completion of the packet transmission to the start of the next packet read at the buffer 31 may assume a difference between a line bandwidth and a setting bandwidth.

Thus, the packet interval is adjusted by the difference between the line bandwidth and the setting bandwidth, thereby enabling the outputted packet to be completely confined within the setting bandwidth and the delay fluctuation time to be minimized.

Furthermore, in the bandwidth control apparatus according to the present invention, an external interface 1, a physical layer controller 2, and an MAC controller 4 may have the same circuit arrangement as a bandwidth control apparatus 3 shown in FIG. 1 for both directions of an up direction (up-link direction) and a down direction (subscriber direction).

A buffer monitor 34 may be further comprised for notifying a stop of a packet transmission to a packet transmitting side when a number of packets residing in the buffer exceeds a first threshold value, and performing a flow control to notify a restart of the packet transmission to the packet transmitting side when the number of packets residing in the buffer becomes equal to or less than a second threshold value.

While it is preferable for the above-mentioned buffer monitor to perform the flow control only to the subscriber side, the flow control may be performed to the up-link side.

Also, the above-mentioned bandwidth control apparatus may be arranged between an MAC layer controller and a physical layer controller, thereby enabling a bandwidth managing system to be provided.

### BRIEF DESCRIPTION OF THE DRAWINGS

FIG. 1 is a block diagram showing an arrangement of an apparatus for realizing a bandwidth control method according to the present invention;

FIG. 2 is a block diagram showing an embodiment in which a bandwidth control method and an apparatus therefor according to the present invention are installed in an Ether switch;

FIG. 3 is a flow chart showing a process example performed at a buffer monitor shown in FIG. 1;

FIG. 4 is a flow chart showing a process example performed at a read controller shown in FIG. 1;

FIG. 5 is a format diagram of a variable length packet used for a bandwidth control method and an apparatus therefor according to the present invention;

FIGS. 6A-6D are time charts of various packets by a bandwidth control method and an apparatus therefor according to the present invention; and

FIGS. 7A and 7B are diagrams showing an interface example of a bandwidth control apparatus according to the present invention.

Throughout the figures, like reference numerals indicate like or corresponding components.

### DESCRIPTION OF THE EMBODIMENTS

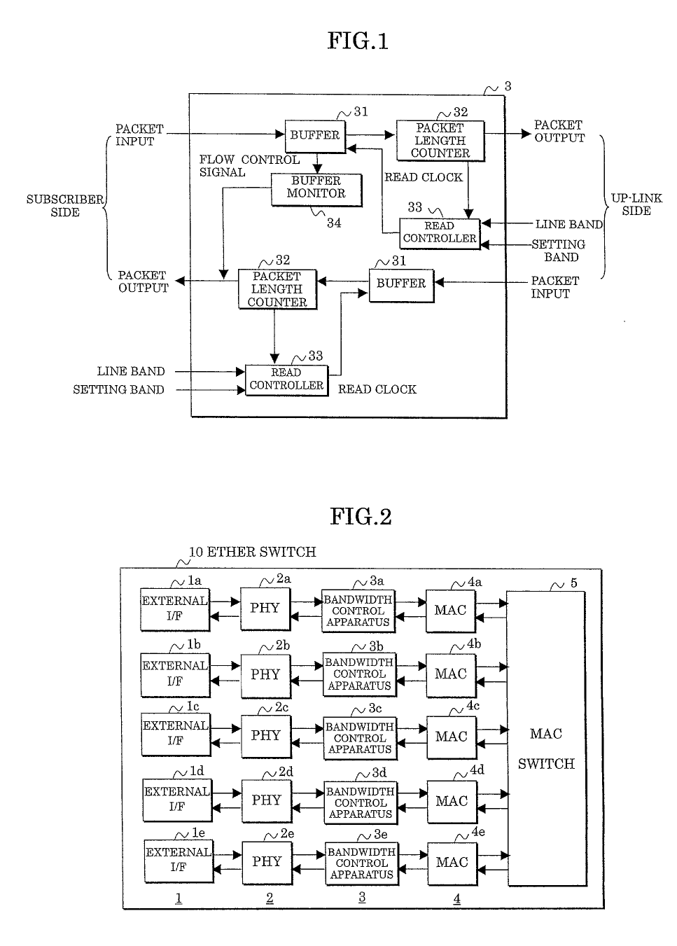

FIG. 2 shows an embodiment in which the bandwidth control apparatus 3 according to the present invention shown in FIG. 1 is incorporated in an Ether switch 10 which is an LAN apparatus.

In this embodiment, the Ether switch 10 has five ports, in which external interfaces (I/F) 1a-1e (hereinafter, occasionally represented by a reference numeral “1”), physical (PHY. IEEE802.3 Physical Sublayer) layer controllers 2a-2e (hereinafter, occasionally represented by a reference numeral “2”), bandwidth control apparatuses 3a-3e (hereinafter, occasionally represented by a reference numeral “3”), and MAC (IEEE802.3 Media Access Control) layer controllers 4a-4e (hereinafter, occasionally represented by a reference numeral “4”) are sequentially connected in series, and an MAC switch 5 is provided commonly to the MAC layer controllers 4.

This MAC switch 5 is connected to each port in series sequentially in the opposite direction through the MAC layer controller 4, the bandwidth control apparatus 3, the physical layer controller 2, and the external interface 1.

Accordingly, each port is switched over at the MAC switch 5 based on the MAC address, so that a variable length packet is relayed to a target port.

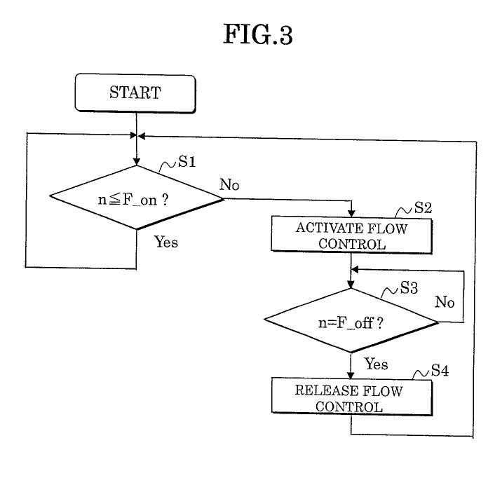

FIG. 3 shows a process flow of the buffer monitor 34 in the bandwidth control apparatus shown in FIGS. 1 and 2. Hereinafter, the operation of the buffer monitor 34 will be described referring to the flow chart. It is to be noted that the buffer monitor 34 serves for performing a flow control, as shown in FIG. 1, to the subscriber side and is not provided on the up-link side.

The packet inputted from the external interface 1 is firstly inputted to the bandwidth control apparatus 3 through the physical layer controller 2 to be stored in the buffer 31 in the bandwidth control apparatus 3. At this time, the number of packets residing in the buffer “n” is incremented and is notified to the buffer monitor 34.

Whether or not the number of packets residing in the buffer “n” exceeds a preset flow control start-threshold value (the first threshold value) F_on is determined (at step S1). When the number of packets residing in the buffer “n”> the flow control start-threshold value F_on, the flow control is activated (at step S2), so that a flow control signal is transmitted to the subscriber side through the physical layer controller 2 and the external interface 1.

Thus, no packet flows into the buffer 31 from the subscriber side. On the other hand, since the packets are read out by the read controller 33, the number of residing packets “n” in the buffer 31 decreases, so that when the number of residing packets “n”=a flow control release-threshold value (the second threshold value) F_off (at step S3), a signal for a flow control release (at step S4) is transmitted to the subscriber side through the physical layer controller 2 and the external interface 1.

Thus, the control is always performed so that the number of packets residing in the buffer 31 may not exceed the flow control start-threshold value.

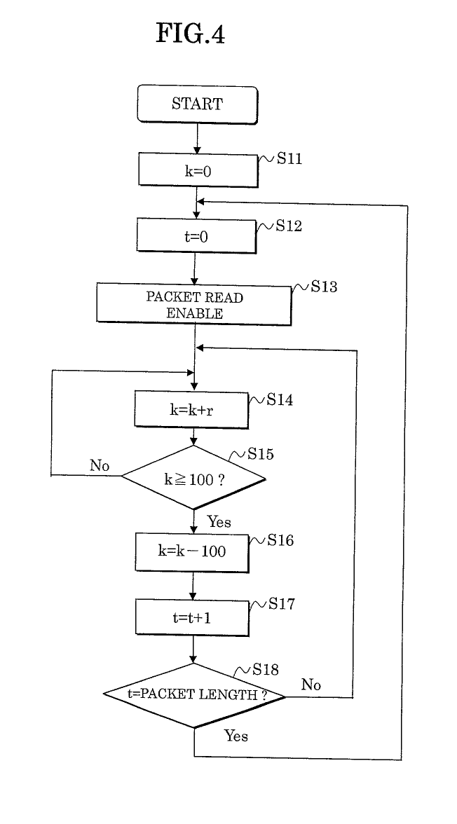

FIG. 4 shows a process flow of the read controller 33 shown in FIG. 1. Hereinafter, its operation will be described referring to the flow chart.

Firstly, a line bandwidth (line speed) provided to the read controller 33 is assumed to be 100 Mbps. A setting bandwidth is represented by a variable “r” (Mbps) assuming an integer from 1 to 100. Also, “k” is a variable for the internal processing, and “t” is a variable, for the internal calculation, counted by the packet length counter 32. In the initial state, k=0 (at step S11) and t=0 (at step S12).

Then, the read controller 33 makes the buffer 31 a packet read enable state (at step S13). Namely, a transmission packet stands by until it is stored in the buffer 31. When it is stored in the buffer 31, a read clock is provided so that the packet may be transmitted.

Then, in order to generate the read clock at the setting bandwidth “r” (Mbps), “k” is firstly assumed to be “k+r” (at step S14), so that whether or not the variable “k” exceeds 100 is determined (at step S15).

If the variable “k” is less than 100, the process returns to step S14, while if the variable “k” assumes 100 or more, k=k−100 is calculated (at step S16).

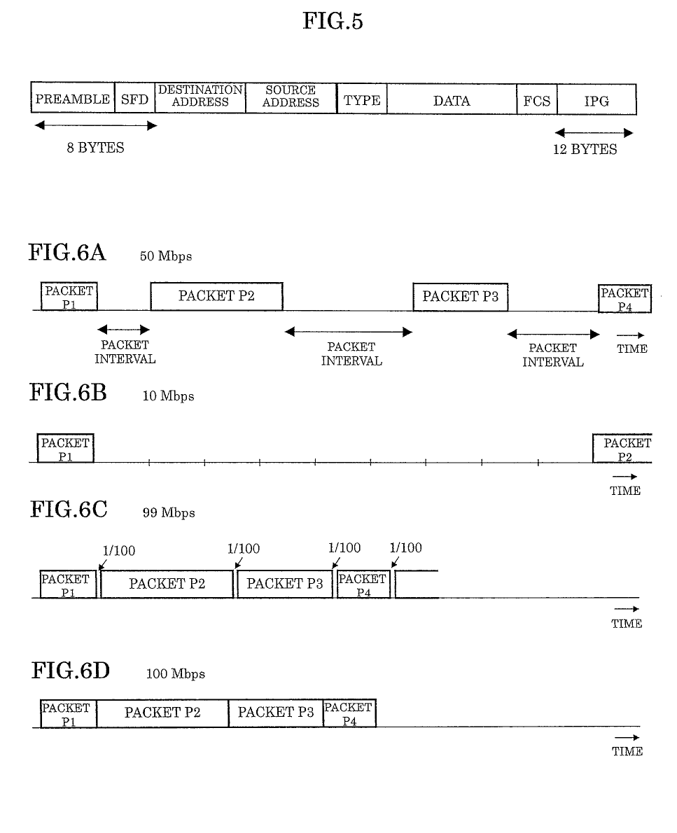

Then, “t” is incremented by “1” (at step S17). These steps are repeated until the variable “t” assumes the packet length of the transmission packet (composed of a preamble, an SFD (Start Frame Delimiter), a destination address, a source address, a packet type (type), data, an FCS (Frame Check Sequence), and an IPG (Inter Packet Gap), as shown in FIG. 5). When “t” is the packet length (at step S18), the process returns to step S12 to read the next packet (at step S13).

Such an operation enables the packet length to be counted at the setting bandwidth, resulting in that a packet interval is inserted at the setting bandwidth before the next packet, thereby enabling the packet transmission at the setting bandwidth to be performed.

FIGS. 6A-6D show time charts of the packets whose bandwidths are actually set as an embodiment. The respective time charts will now be described referring to FIGS. 4 and 5.

(1) In Case Setting Bandwidth is 50 Mbps (50% of Line Speed): see FIG. 6A

In this case, “r” is 50, and when the packet having data length of 64 bytes is transmitted, the packet length to which the preamble and the like are added assumes 84 bytes.

After “k” and “t” are initialized at steps S11 and S12 in the flow chart of FIG. 4 and the buffer 31 is then made to be in the packet read enable state (at step S13), “k” assumes 0+50=50. Since “k” is smaller than 100, “r” is again added to “k” at step S14. As a result, “k” assumes 50+50=100.

Accordingly, since “k” assumes 100 or more (at step S15), 100 is subtracted from “k” (at step S16), and “t” is incremented by “1” (at step S17), so that “t” is compared with the packet length given from the counter 32 (at step S18). Since “t” does not yet reach the packet length at this time, 50 is again added to “k” at step S14.

Thus, “k” assumes 50 again, so that the process returns from step S15 to step S14 in the same way as the above. Then, 50 is further added, which provides “k”≧100, so that 100 is subtracted at step S16.

Namely, “k” assumes 100 during two loops of the process flow and “1” is added to “t”. Therefore, if the processing of k=k+r is performed at the line speed, the increment of “t” is performed once every two clocks of the line speed, i.e. at the speed of 50% of the line speed.

Since this operation is repeated until “t” assumes the packet length, the result is that the front-end of the packet transmission is kept waiting for the packet length time at 50 Mbps which is 50% of the line speed as the setting bandwidth.

Namely, as a result, the packet interval is spaced after the packet transmission (see FIG. 6A). Since 50 Mbps is set in this case, the packet interval just the same as the packet length is inserted.

(2) In Case Setting Bandwidth is 10 Mbps (10% of Line Speed): see FIG. 6B

Since “r”=10 in this case, the operation of k=k+r is required to be performed 10 times so that “k” may assume 100.

Namely, for the line speed, “t” is incremented only once every ten times. Since the operation is repeated until “t” assumes the packet length, the next packet can not be eventually transmitted from the buffer 31 for a time interval 10 times as long as the line speed.

(3) In Case Setting Bandwidth is 99 Mbps (99% of Line Speed): see FIG. 6C

Since “r”=99 in this case, “k” assumes 198 after performing the process twice, which exceeds 100 . After incrementing “t”, 100 is subtracted therefrom, so that “k” assumes 98.

“k” assumes 98+99=197 in the following process, and by incrementing “t”, “k” assumes 97.

With this operation repeated, “k” is decremented by “1” until “k” finally assumes 0 to return to the initial state. Only when “k”=0, “r” is required to be added twice at step S14 in order to make “k”≧100.

Namely, in order to increment “t” once every one hundred times, a single clock is required to be waited. Therefore, the packet is counted by 99% of the line speed, so that the interval of a single clock is to be inserted before the next packet.

(4) In Case Setting Bandwidth is 100 Mbps (Line Speed): see FIG. 6D

Since “k”≧100 without fail at step S15 in FIG. 4 in this case, steps S14 to S17 are processed without fail. Accordingly, the packet interval does not take place, so that, as shown in FIG. 6D, the packets P1-P4 are continuously transmitted.

The flow chart shown in FIG. 4 is composed of three loops. To process these loops, an FPGA (Field Programmable Gate Array) may be used. If this FPGA is used for example, an outer loop of steps S12-S18, a middle loop of steps S14-S18, and an inner loop of steps S14-S15 are composed of gate arrays.

However, different from the execution of a computer program, these loops operate so that each loop may complete the process with a single clock regardless of the number of steps. This single clock corresponds to a time of transferring an arbitrary single bit of the packet. Furthermore, an adequate clock speed can be set according to the line speed.

Also, as another embodiment, it is possible to set a setting bandwidth with percentage. Namely, by fixedly setting 100 for the value of “k”, and setting the values of 1-100 (percentage) for the value of “r”, it becomes possible to control “r” % of the line bandwidth as the setting bandwidth.

It is to be noted that since each packet has the IPG region as shown in FIG. 5, each packet has a fixed interval for this IPG region when “r”100 (Mbps).

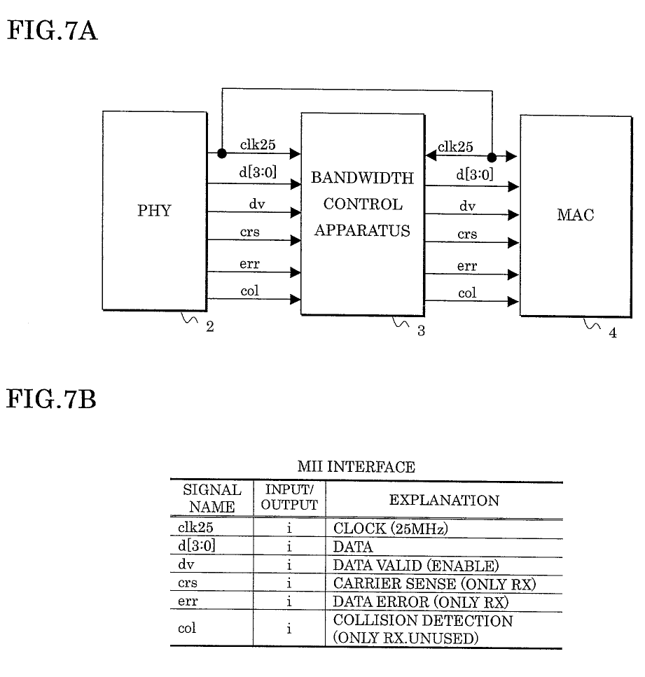

FIG. 7A shows an embodiment in case where an MII (Media Independent Interface) is used as an interface when the bandwidth control apparatus 3 according to the present invention, as shown in FIG. 2, is arranged between the physical layer controller 2 and the MAC layer controller 4.

In the MII interface in this case, as shown in FIG. 7B, a signal “clk25” is for a clock of 25 MHz, “d[3:0]” is for data, “dv” is for data valid (enable), a signal “crs” is for carrier sense (only receiving), a signal “err” is for data error (only receiving), and further “col” is for collision detection (only receiving, unused).

It is to be noted that since the bandwidth control apparatus 3 internally controls the packet interval in the present invention, the bandwidth control apparatus has an excellent matching with an external circuit. It is also possible to make modification not only to the MII interface but also to an RMII or SMII interface in case of 100 Mbps communication, a GMII interface in case of 1 Gbps communication, and the like. Such interfaces as the MII, the RMII, the SHII, and the GII are generally called a standard interface.

As described above, a method, an apparatus, and a system for a bandwidth control according to the present invention are arranged so that a variable length packet is held in a buffer, the held packet is read at a line bandwidth, and a read timing of a next packet is controlled, based on a packet length of a counted packet, in order that a difference between the line bandwidth and a setting bandwidth may assume a packet interval. Therefore, it becomes possible to perform a bandwidth control without exceeding the setting bandwidth even temporarily and with a delay fluctuation time being minimized.

Furthermore, by a flow control combined therewith, the bandwidth control can be realized as a system without discarding any packet or with a low packet discarding rate.

Also, by arranging the bandwidth control function according to the present invention between an MAC layer controller and a physical layer controller, the bandwidth control independent of a read scheduler of an MAC switch can be realized.

What we claim is:

1. A bandwidth control method comprising the steps of:
holding a packet,
counting a packet length of the packet, and
reading the held packet at a line bandwidth and controlling a read start timing of a next packet, based on the packet length, in order that a difference between the line bandwidth and a setting bandwidth assumes a packet interval.

2. The bandwidth control method as claimed in claim 1, further comprising the steps of notifying a stop of a packet transmission to a packet transmitting side when a number of packets residing in a buffer exceeds a first threshold value, and performing a flow control to notify a restart of the packet transmission to the packet transmitting side when the number of packets residing in the buffer assumes equal to or less than a second threshold value.

3. The bandwidth control method as claimed in claim 2 wherein the flow control is performed only to a subscriber side.

4. The bandwidth control method as claimed in claim 1 wherein the method is performed between an MAC layer process and a physical layer process.

5. A bandwidth control apparatus comprising:
a buffer for holding a packet,
a counter for counting a packet length of the packet, and
a read controller for reading the packet at a line bandwidth from the buffer and controlling a read start timing of a next packet, based on the packet length, in order that a difference between the line bandwidth and a setting bandwidth assumes a packet interval.

6. The bandwidth control apparatus as claimed in claim 5, further comprising a buffer monitor for notifying a stop of a packet transmission to a packet transmitting side when a number of packets residing in the buffer exceeds a first threshold value, and performing a flow control to notify a restart of the packet transmission to the packet transmitting side when the number of packets residing in the buffer becomes equal to or less than a second threshold value.

7. The bandwidth control apparatus as claimed in claim 6 wherein the buffer monitor performs the flow control only to a subscriber side.

8. A bandwidth control system arranging the bandwidth control apparatus mentioned in claims 5 to 7 between an MAC layer controller and a physical layer controller.

9. The bandwidth control system as claimed in claim 8 wherein an interface with each layer controller comprises a standard interface.

10. The bandwidth control apparatus as claimed in claim 5 wherein the packet has a variable length.
